(19) United States
(12) Patent Application Publication
(10) Pub. No.: US 2025/0124825 A1
(43) Pub. Date: Apr. 17, 2025

(54) Improved Adjustable Canvas Wrap Frame Mounting System

(71) Applicant: Cody Vedvig, Prescott, AZ (US)

(72) Inventor: Cody Vedvig, Prescott, AZ (US)

(21) Appl. No.: 18/688,583

(22) PCT Filed: Jan. 16, 2024
(86) PCT No.: PCT/US2024/011612

§ 371 Date: Mar. 1, 2024

Related U.S. Application Data
(60) Provisional application No. 63/441,902, filed on Jan. 30, 2023.

(51) Int. Cl. G09F 7/18

(52) U.S. Cl. CPC G09F 7/18; G09F 2007/1843

(57) ABSTRACT

The present invention includes system, methods, and device for coupling and de-coupling secondary decorative displays with an image frame, such as a canvas wrap, as well as methods and devices to adjust the dimensions of such secondary decorative displays to secure, and accommodate various sized frames.

### CROSS-REFERENCE TO RELATED APPLICATIONS

This International PCT application claims the benefit of and priority to U.S. Provisional Application No. 63/441,902 filed Jan. 30, 2023. The specification, claims, and drawings of which are incorporated herein by reference in their entirety.

### TECHNICAL FIELD

The invention relates to the field of image frames, and in particular an improved system to adjustably mount, secure and display a framed image, such as a stretch canvas wrap.

### BACKGROUND

Canvas art, such as gallery canvas wraps, are often presented in a frame. Typically, a section of canvas displaying the desired image or artwork is stretched and stapled to an internal wooden or composite frame. The dimensions of the canvas can vary considerably, but the height of the frame (i.e. the distance between the wall and the attached canvas) has different standard dimensions.

However, in the case of canvas wraps, the image or artwork extends to the edge of the frame making it difficult and impractical to display the canvas wrap in a secondary or external decorative frame. For example, traditional frames require the canvas to be slotted into the frame where a portion of the image or artwork may be covered. In addition, the dimension of typical artwork frames are fixed and static and as such, cannot be adjusted to fit different sized images, such as canvas wraps.

Therefore, there exists a need for a practical solution for displaying a canvas wrap image in a secondary decorative display, which may also be adjustable so as to be able to accommodate a variety of differently sized canvas wrap images. Moreover, there is a long-felt need for simple methods and apparatus for quickly coupling and de-coupling secondary decorative displays with an image, such as a canvas wrap, as well as methods and devices to adjust the dimensions of such secondary decorative displays to secure, and accommodate various sized frames.

### SUMMARY OF THE INVENTION

One another aspect of the present invention is directed systems, methods and apparatus for securing one or more display supports to a frame, and preferably the frame of a canvas wrap or other art or marketing display. In one preferred aspect, the invention includes magnetic frame mount assembly configured to secure one or more display supports to a frame using one or more magnetic couplers. The magnetic coupler of the invention can include a frame catch having a contact surface that is securable to (or integral with) a plate. In this aspect, the contact surface of the frame catch is positioned adjacent to the frame, and preferably underneath the extended surface of the internal frame, while the plate magnetically engages a magnet positioned, preferably in the notch of a rail support that is further secured to a corresponding display support.

In another aspect, the present invention is directed systems, methods and apparatus for securing a decorative cap onto the terminal edge of a display support that is further coupled with a frame, and preferably the frame of a canvas wrap or other art or marketing display. In this preferred aspect, the invention includes a magnetic end cap configured to be magnetically engaged with the terminal portion of a display support. In one aspect, the magnetic end cap includes at least one end cap magnet configured to be engaged with a magnetic coupler position on the terminal edge of a display support.

In another aspect, the present invention is directed systems, methods and apparatus for securing a frame, and preferably the frame of a canvas wrap or other art or marketing display, with one or more display supports. In this preferred aspect, the invention includes a pivot fastener having a fastener position at one terminal fastener position and a slot on the opposing end of the pivot fastener. In this aspect, the terminal fastener position can be secured to the edge of a frame, and the slot can be positioned to allow it to further be secured to a display support positioned adjacent to the frame, and optionally the opposing edge of the frame, thereby securing the frame to the display support.

In another aspect, the present invention is directed to an extendable display surface that can be configured to be secured to the distal portion of a display support that is further secured to a frame, and preferably the frame of a canvas wrap or other art or marketing display. In this preferred aspect, the extendable display surface of the invention can include a front and edge surface forming an extendable channel configured to be slidably coupled to the terminal portion of a display support. Alternative aspects may further include an extendable display surface a back, end, and top surfaces that can be configured to be secured to the distal portion of a display support that is further secured to a frame, and preferably the frame of a canvas wrap or other art or marketing display.

Further objects of the inventive technology will become apparent from the description and drawings below.

### BRIEF DESCRIPTION OF DRAWINGS

The novel aspects, features, and advantages of the present disclosure will be better understood from the following detailed descriptions taken in conjunction with the accompanying figures, all of which are given by way of illustration only, and are not limiting the presently disclosed embodiments, in which:

FIG. 1: is a front image of a canvas wrap frame mount securing a canvas wrap image display in one embodiment thereof,

FIG. 2: is a back image of a canvas wrap frame mount having an upper and lower support securing a canvas wrap image display in one embodiment thereof;

FIG. 3: is an image of a canvas wrap frame mount having upper and lower support securing a canvas wrap image display with a plurality of adjustable couplers in one embodiment thereof;

FIG. 4: is an image of a canvas wrap frame mount having a lower support securing a canvas wrap image display;

FIG. 5: is a back view of an isolated support of a canvas wrap frame mount in one embodiment thereof,

FIG. 6: is a back view of an isolated support of a canvas wrap frame mount in one embodiment thereof,

FIG. 7: is a front image of an expandable canvas wrap frame mount having a plurality of upper and lower slide display supports coupled with a baseplate securing a canvas wrap image display in one embodiment thereof;

FIG. 8: is a front image of an expandable canvas wrap frame mount having a plurality of independently movable upper and lower slide display supports coupled with a baseplate through a plurality of mount support each coupled with an interlocking rail slide positioned within a recessed position on the rear surface of the baseplate in one embodiment thereof;

FIG. 9: is a front perspective view of an isolated upper independently movable upper slide display support having a plurality of adjustable couplers configured to secure a canvas wrap frame in one embodiment thereof,

FIG. 10: is a front perspective view of an isolated upper independently movable upper slide display support having a plurality of adjustable couplers configured to secure a canvas wrap frame in one embodiment thereof;

FIG. 11: is an expanded view of an adjustable coupler secured to a display support in one embodiment thereof;

FIG. 12 is a top perspective view of an isolated upper independently movable upper slide display support having a plurality of adjustable couplers configured to secure a canvas wrap frame in one embodiment thereof;

FIG. 13 is a top perspective view of an isolated upper independently movable upper slide display support having a plurality of adjustable couplers configured to secure a canvas wrap frame in one embodiment thereof;

FIG. 14 is a back view of an isolated upper independently movable upper slide display support having a plurality of interlocking rail slides each positioned within a recessed position on the baseplate and further coupled with a support mount; and

FIG. 15 is a back view of an isolated upper independently movable lower slide display support having a plurality of interlocking rail slides each positioned within a recessed position on the baseplate and further coupled with a support mount.

FIG. 16 is a canvas wrap frame mount having upper and lower support securing a canvas wrap image display securing a support rail that is configured to be magnetically securable to one or more magnetic couplers in one embodiment thereof;

FIG. 17 is an isolated perspective view of a magnetic coupler having a frame catch securable to a plate having a plurality of adjustable apertures in one embodiment thereof;

FIG. 18 is a canvas wrap frame mount having upper and lower support securing a canvas wrap image display having magnetic end-caps secured to the terminal portion of the upper and lower display supports in one embodiment thereof;

FIG. 19 is a top view of a canvas wrap frame mount having upper and lower support securing a canvas wrap image display and securing a support rail that is configured to be magnetically securable to one or more magnetic couplers and magnetically securable end caps in one embodiment thereof;

FIG. 20 is a perspective view of a canvas wrap frame mount having upper and lower support securing a canvas wrap image display and securing a support rail that is configured to be magnetically securable to one or more magnetic couplers having a vertical plate with a plurality of adjustable apertures further secured to a frame catch in one embodiment thereof;

FIG. 21 is a perspective view of a canvas wrap frame mount having upper and lower support securing a canvas wrap image display and securing a support rail that is configured to be magnetically securable to one or more magnetic couplers having a vertical plate with a plurality of adjustable apertures further secured to a frame catch and wherein the display supports is coupled with a magnetic end-cap in one embodiment thereof;

FIG. 22 is a blown-up view of a magnetic end-cap securable to a display support in one embodiment thereof;

FIG. 23 is a blown-up view of a magnetic end-cap securable to a display support having a magnetic coupler position in one embodiment thereof;

FIG. 24 is a blown-up view of a magnetic end-cap securable to a display support having a magnetic coupler position in one embodiment thereof;

FIG. 25 is a front view of a pivot fastener having a slot position secured to the frame of a canvas wrap and display support in one embodiment thereof;

FIG. 26 is a front view of a pair pivot fasteners each having a slot position secured to the corner portion of the frame of a canvas wrap and display support in one embodiment thereof;

FIG. 27 is a perspective view of a pair pivot fasteners each having a slot position secured to the corner portion of the frame of a canvas wrap and display support in one embodiment thereof;

FIG. 28 is a back perspective view of an extendable display surface securable to a display support in one embodiment thereof;

FIG. 29 is a back perspective view of an alternative extendable display surface securable to a display support in one embodiment thereof;

FIG. 30 is a back perspective view of an alternative extendable display surface securable to a display support in one embodiment thereof;

FIG. 31 is a front view of a pivot fastener having a slot position secured to the frame of a canvas wrap and the display support of an expandable canvas wrap frame mount in one embodiment thereof;

FIG. 32 is a front view of a plurality of pivot fastener having a slot position secured to the corner position of the frame of a canvas wrap and the display support of an expandable canvas wrap frame mount in one embodiment thereof;

FIG. 33 is a back perspective view of a display cover slidably coupled with a pair of opposing extendable display surfaces in one embodiment thereof, and

FIG. 34 is a front perspective view of a display cover slidably coupled with a pair of opposing extendable display surfaces in one embodiment thereof.

### DETAILED DESCRIPTION OF INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

The invention may include a novel design for a canvas wrap frame mount (1). In one preferred embodiment the canvas wrap frame mount (1) of the invention may include one, or a plurality of display supports (2,3). As generally shown in FIGS. 3-6, a display may be configured to be positioned along the outer edge of an internally framed canvas wrap, or another framed image or artwork. In the preferred embodiment shown in the figures, a canvas wrap (10) may be positioned between an upper display support (2) and a lower display support (3). It should be noted that, while the images demonstrate two distinct display supports (2,3) which are made of linear shaped beams, this is not limiting on the number and shape of the display supports (2,3), nor the variety of material that may be encompassed within this disclosure. As noted below, in certain embodiments, design elements such as shape and color may be added to the display supports (2,3,16,17) and baseplate (15) of the invention.

Again, referring to FIG. 3-6, a display support (2,3) may include a display surface (9) that may be facing in the same direction as the image display (4) surface of the canvas wrap (10). A display support (2,3) may further include a support surface (8) that is positioned to be in the same direction as the back of the canvas wrap (10). (Notably, while referenced oftentimes in the plural, reference to a display support (2,3) can mean one or a plurality of display supports.)

In another embodiment, one or more adjustable couplers (7) may be positioned on the support surface (8) of a display support (2,3). As specifically highlighted in FIG. 3, a plurality of adjustable couplers (7) may be secured to the support surface (8) of an upper and lower display support (2,3). In this preferred embodiment, an adjustable coupler (7) may be secured to the support surface (8) of a display support (2,3) through a coupler/fastener, such as a screw or nail or other similar fastening mechanisms. The adjustable coupler (7) may further be configured to extend outward from the display support (2,3) and may further include a frame catch (11) that may be positioned near the internal frame (5).

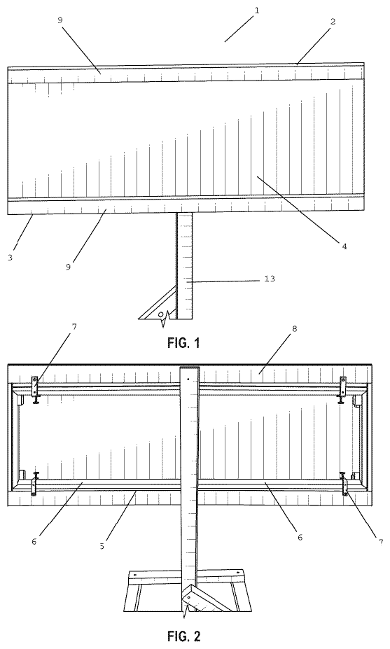

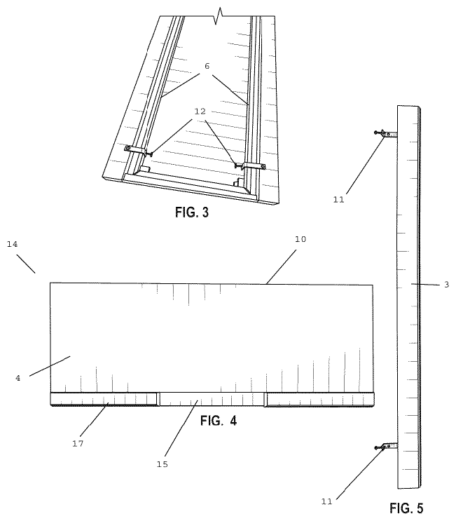

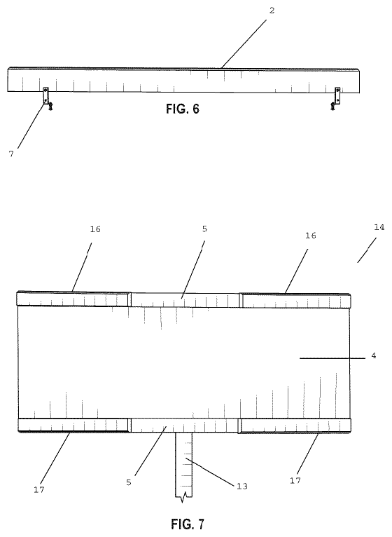

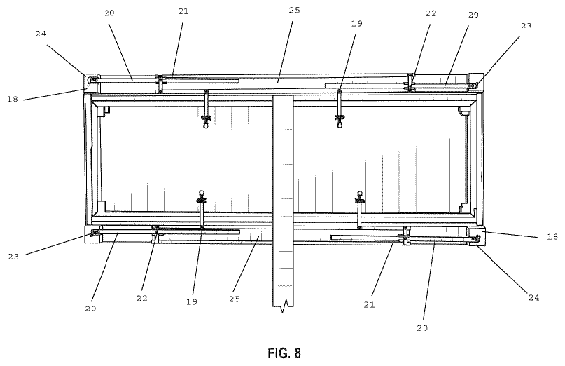

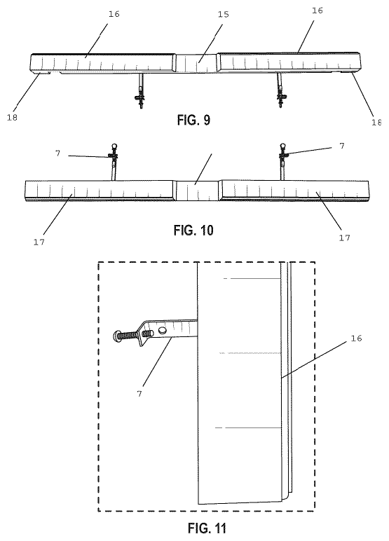

Generally referring to FIGS. 1-2, a canvas wrap frame mount (1) may be formed by placing an upper and lower display support (2,3) along the top and bottom leading edges of a canvas wrap (10). The internal frame (5) supporting the canvas wrap (10) may then be secured to the upper and lower display support (2,3) with the image display (4) facing the same direction as the display surface of the upper and lower display support (2,3) forming a desired presentation. As highlighted in FIGS. 2-4, the internal frame (5) may be positioned such that its frame edge (6) is placed in close proximity to an adjustable coupler (7), and in particular a frame catch (11). In this preferred embodiment, an adjustable compressor (12) may be brought into contact with the frame edge (6) and secure the internal frame (5) to the upper and lower display support (2,3) forming a canvas wrap frame mount (1). While the preferred embodiment shown in the figures uses a screw compression element, any appropriate coupler may be employed by the invention. For example, a spring-loaded coupler, a snap coupler, a slide coupler, and the like may be used to secure the internal frame (5) to the upper and lower display support (2,3) forming a canvas wrap frame mount (1).

Naturally, a canvas wrap frame mount (1) may include one or more side display supports (not shown) that may be similarly positioned. In still further embodiment, the upper and lower display supports (2,3) may extend along the horizontal as well as vertical edges of a canvas wrap (10), partially or fully encasing the image display (4). In some embodiment, the upper and lower display supports (2,3) may form a unitary component that may be secured to a canvas wrap (10) as generally described herein, such that the unitary display supports the fully encased image display (4).

In certain embodiments, this adjustable coupler (7) may include a limited profile such that it may be approximately flush with the support surface (8) of a display support (2,3). In this configuration, the canvas wrap frame mount (1) may be hung on a wall or other similar surface, such that the mount may be approximately flush with the surface. In additional embodiments, a canvas wrap frame mount (1) may be secured by a display stand (13) or other similar support. In one preferred embodiment, a display stand (13) may be coupled with one or more elements of the canvas wrap frame mount (1), for example through a fastener, such as a screw or nail, or a coupler such as a clamp or snap lock.

As noted above, art frames, and in particular canvas wrap frames are generally static and cannot be adjusted to accommodate image displays of varying dimensions. This is especially prevalent as the popularity of oversized canvas wraps artwork has gained popularity over the years. To address this limitation, another preferred embodiment of the invention may include an expandable canvas wrap frame mount configured to be expanded vertically and optionally horizontally to accommodate canvas wraps of varying sizes and dimensions.

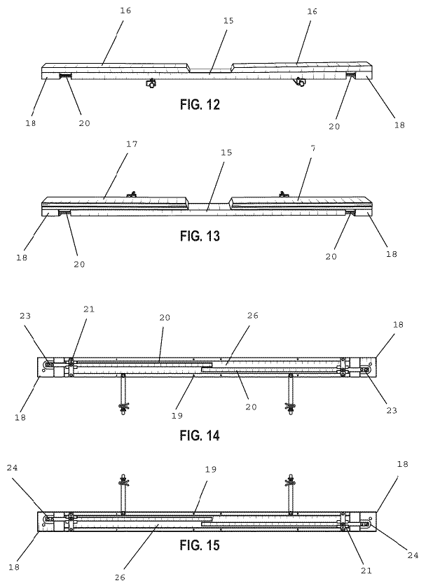

Generally referring to FIGS. 7-15, invention may include a novel design for an expandable canvas wrap frame mount (14). In one preferred embodiment the expandable canvas wrap frame mount (14) of the invention may include one, or a plurality of slide display supports (16, 17).

As generally shown in FIG. 7, one or more slide display supports (16, 17) may be configured to be positioned along the outer edge of an internally framed canvas wrap (10), or another framed image or artwork. In the preferred embodiment shown in the figures, a canvas wrap (10) may be positioned between an upper slide display support (16) and a lower slide display support (17). In an alternative embodiment shown in FIG. 4, a single lower slide display support (16) may be configured to be positioned along the outer edge, and in this case the bottom leading edge, of an internally framed canvas wrap (10), or another framed image or artwork. As noted elsewhere, while the figures demonstrate an upper and lower slide display support (16, 17) positioned along the top and bottom of a canvas wrap (10), side slide display supports operating in a similar to the lower slide display supports (16, 17) may also be encompassed within the scope of the invention. Also, it is notable that in certain embodiments, upper and lower display supports of the invention may be configured to be interchangeable.

Referring specifically to FIGS. 7-8, the exemplary slide display supports (16, 17) may include a baseplate (15) having a front display surface (9) that may be facing in the same direction as the image display (4) surface of the canvas wrap (10). The slide display support(s) (16,17) of this embodiment may further include a rail support surface (25) that is positioned to be in the same direction as the back of the canvas wrap (10).

The baseplate (15) of the invention may be slidably coupled with a plurality of independently expandable slide display support(s) (16,17) such that the display supports positioned along one or more outer surfaces of a canvas wrap (10) may be independently expanded or contracted along the leading edge of the canvas wrap (10). In this embodiment shown in FIGS. 8, 12-15, the baseplate (15) of the invention may include a plurality of recessed rail guides (26) configured to each slidably secure at least one interlocking rail slide (20). In this configuration, an interlocking rail slide (20), such as a metal rod or other similar support components may be positioned within the recessed formed by the recessed rail guides (26) such that they may be positioned substantial flush with, or below the rail support surface (25) of the baseplate (15) of the invention.

Referring now to FIGS. 8 and 14-15, in this embodiment each interlocking rail slide (20) may be positioned within the recessed rail guides (26) of the baseplate (15) with the terminal end of the rail being further secured to a support mount (18). As shown in FIG. 8, the terminal end of the interlocking rail slide (20) may be positioned within a mount recess (24) on the support mount (18) such that it is substantial flush with, or below the rear surface of the support mount (18), and further secured to the support mount (18) by a mount coupler (23). The mount coupler (23) of the invention may include for example a fastener, such as a screw or nail, or a coupler such as a clamp or snap lock that may further be positioned substantial flush with, or below the rear surface of the support mount (18).

Referring again to FIGS. 1 and 12-15, in this embodiment a support mount (18) secured to a rail may be coupled with and interlocking rail slide (20) may be secured to an independently expandable slide display support(s) (16,17) such that expansion and/or retraction of the independently expandable slide display support(s) (16,17) may cause the display supports (16,17) to independently expand or contract along the length of the baseplate (15) of the invention. Notably, in this embodiment, the baseplate (15) remains static compared to the movement of the independently expandable slide display support(s) (16,17) such that the display surface of the baseplate (15) is not physically connected to the independently expandable slide display support(s) (16,17).

As shown in FIG. 8, the independently expandable slide display support(s) (16,17) may be extended to a customizable length to fit the size of a canvas wrap (10) with the interlocking rail slides (20) providing a rigid frame network for the display support(s) (16,17) while configured in the extended configuration. Notably, while in the contracted configuration, the interlocking rail slides (20) may be positioned within their respective recessed rail guides (26) in an interlocking configuration. As a result, in certain embodiments, the mount recesses (24) on their respective support mounts (18) may be configured in an off-set configuration to accommodate the position of the interlocking rail slides (20).

Again, referring to FIG. 14-15, in one preferred embodiment one or more of the interlocking rail slides (20) of the invention may be further secured by a rail guide (21). In this embodiment, a rail guide (21) may be positioned on the rail support surface (25) of the baseplate (15) and may support and maintain the position of the interlocking rail slides (20) during their transit. The use of one or more rail guides (21) may be especially applicable when the recessed rail guide (26) of the invention comprise a single recessed position on the rail support surface (25) of the baseplate (15). In this preferred embodiment, a rail guide (21) may be positioned at the terminal ends of the rail support surface (25) of the baseplate (15) and configured to slidably secure one or more interlocking rail slides (20) into a desired substantially vertical, horizontal or angled orientation as may be desired.

Additional rail guides (21) may be positioned on the rail support surface (25) of the baseplate (15) and configured to support and orientate the interlocking rail slides (20) of the invention. In still further embodiment, one or more rail couplers (22) may be configured to secured one or more rail guides (21) positioned on the rail support surface (25) of the baseplate (15). This optional embodiment may include a cross-bean securing the one or more rail guides (21) in position, while providing a top surface of rail guides (21) further securing the interlocking rail slides (20) into a desired substantially vertical, horizontal, or angled orientation as may be desired.

As shown in FIG. 8, in this embodiment one or more adjustable couples may be secured to the rail support surface (25) of the baseplate (15), and more specifically along the proximal and/or distal ridge (19) formed by the recessed rail guides (26).

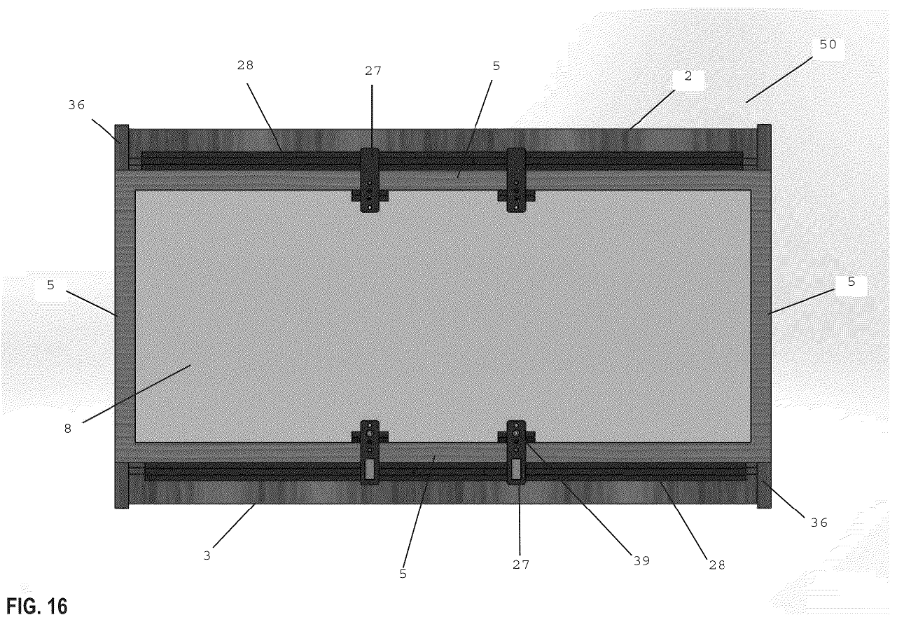

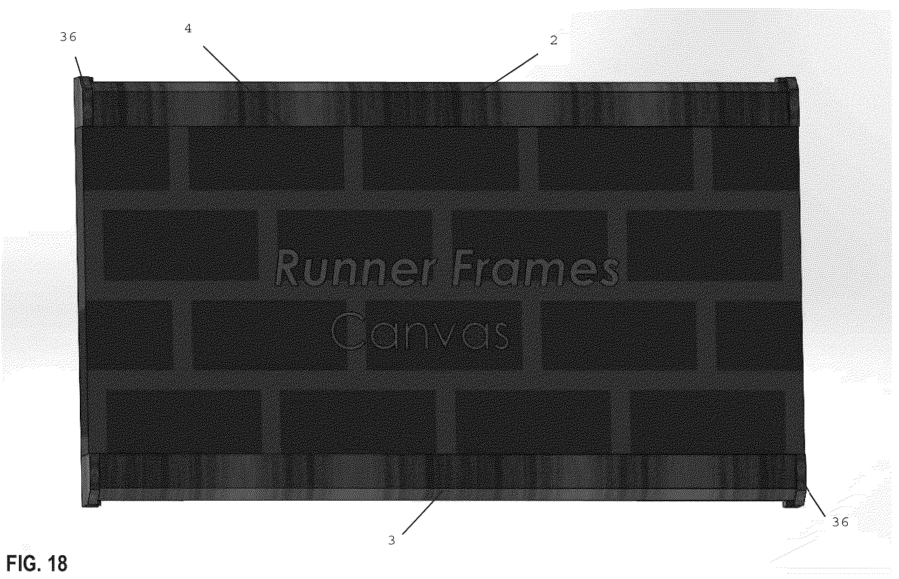

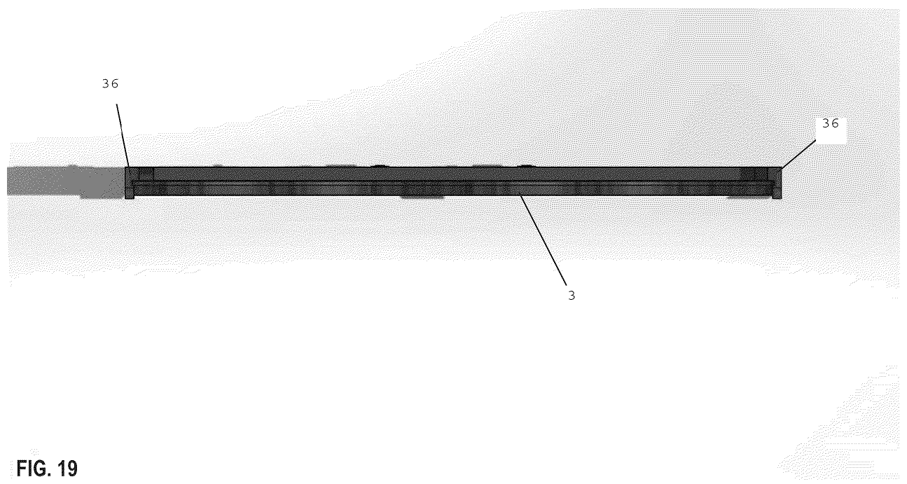

The present invention includes systems and methods to magnetically mount a display, such as a canvas wrap (10) as described herein. In one preferred embodiment the magnetic canvas wrap frame mount (50) of the invention may include one, or a plurality of display supports (2,3) that can be configured to magnetically secure a display, such as preferably a canvas wrap (10), through one or more magnetic couplers (27). Generally referring to FIGS. 16-21, in this embodiment a canvas wrap is positioned adjacent to an upper and lower display support (2,3). Each display support (2,3) further includes a support rail (28) positioned on the support surface (8) of the respective display support (2,3). As specifically shown in FIG. 16, in one preferred embodiment, the support rail (28) of the invention is positioned adjacent to the edge of the frame (5) of a preferred canvas wrap (10).

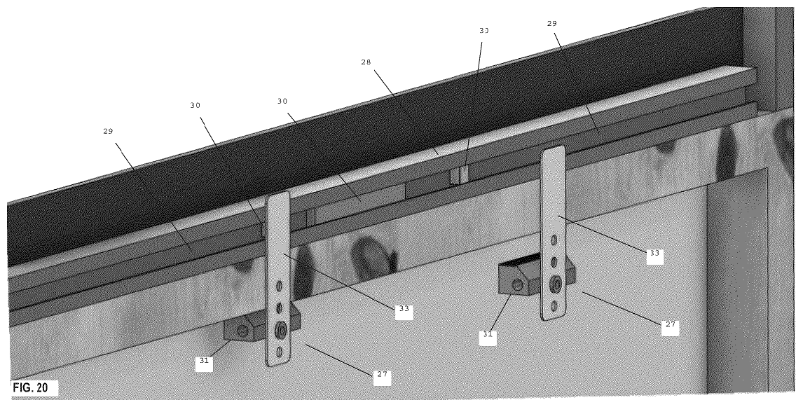

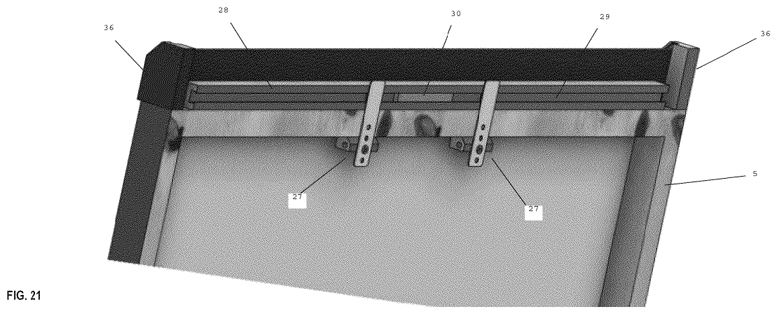

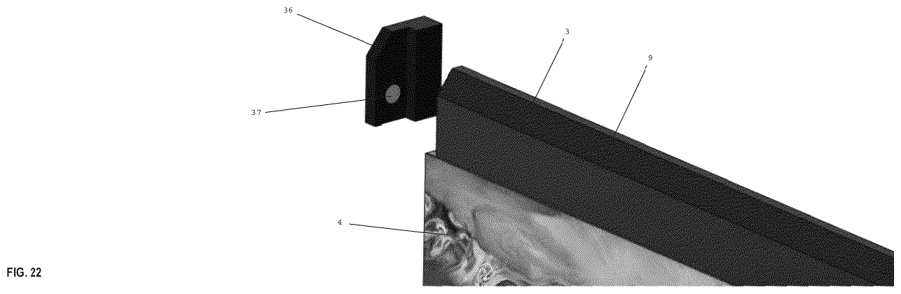

The magnetic canvas wrap frame mount (50) of the invention may further include one or more magnets (30) configured to be coupled to the support rail (28). In the preferred embodiment shown in FIGS. 20-21, one or more magnets (30) may be positioned within a notch (29) running along the support surface (8) of the support rail (28). The magnet(s) (30) of the invention can be configured to be slidably engaged with the notch (29) of the support rail (28) such that their position along the notch can be adjusted as desired by the user. Notably, while in the preferred embodiment shown in the figures describes a support rail (28) may extend approximately the length of the upper and lower edges of the frame (5), in certain alternative embodiment the support rail (28) of the invention may include one, or a plurality of discrete support rails (28) that can be positioned at different locations along the edge of the frame (5). In such an embodiment, a corresponding magnet (30) may be secured to a discrete support rail (28) in a static, or adjustable fashion as generally described herein.

In alternative embodiments, the magnetic canvas wrap frame mount (50) of the invention may include one or more side display supports (not shown) that may be similarly positioned along the horizontal edges of the frame (5), and may further include a support rail (28) secured to its support surface (8) configured to be coupled with one or more magnets (30), preferably by positioning then within the notch (29) of the support rail (28). In this configuration, as described below, one or more magnetic couplers (27) can be used to secure both the horizontal and/or vertical edges of the frame (5) to an adjacent display support (2,3).

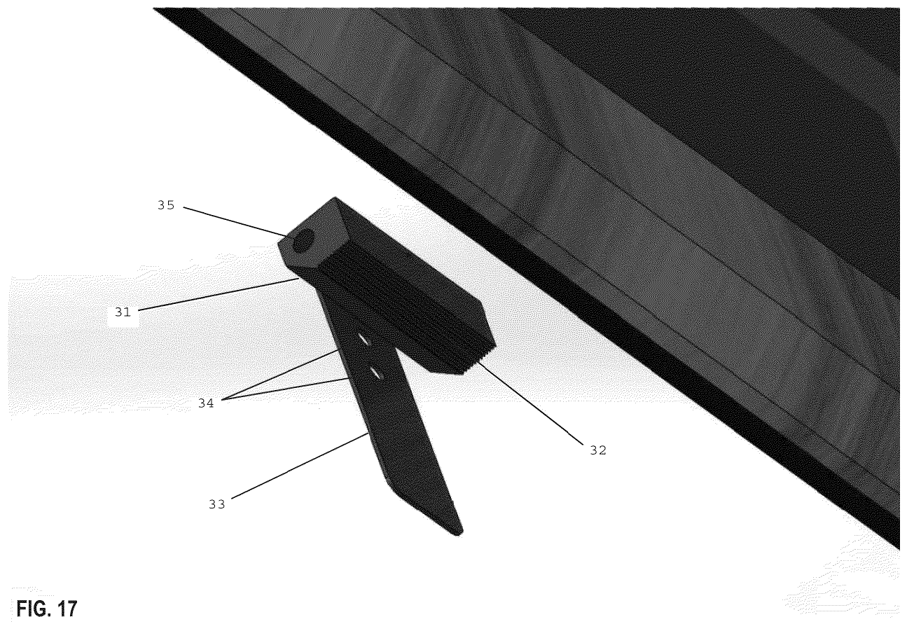

The magnetic canvas wrap frame mount (50) of the invention may further include one or more magnetic couplers (27) configured to secure both the horizontal and/or vertical edges of the frame (5) to an adjacent display support (2,3). In the preferred embodiment shown in FIG. 17, the magnetic couplers (27) of the invention can include a frame catch (31) configured to be secured to a plate (33), preferably through one or more adjustment apertures (34). Again, referring to FIG. 17, an exemplary frame catch (31) of the invention may include an elongated member having a contact surface (32) configured to be positioned adjacent to, and secure the frame of the invention. In a preferred embodiment, the contact surface (32) of the invention may be corrugated, or roughened such that it has an improved surface that can grip and prevent the movement of the secured portion of the frame. The frame catch (31) of the invention may further include a catch channel (35) that may form a hollow aperture traversing lengthwise along the body of the frame catch (31). In this embodiment, the catch channel (35) reduces the overall weight of the frame catch (31) and provides additional compressive response when the frame catch (31) is secured to the adjacent portion of a frame (5).

As noted above, the magnetic coupler (27) of the invention includes a plate (33) configured to be secured to the rear surface of the frame catch (31). In this embodiment, the plate (33) includes a series of adjustment apertures (34) running lengthwise along the body of the plate (33). Based on the desired length of the plate (33) that extends from the frame catch (31), a user can select the appropriate adjustment aperture (34) and match it with a corresponding aperture position (not shown) on the rear surface of the frame catch (31). The plate may be secured through such apertures by one or more fasteners (39), or couplers which would be understood by one or ordinary skill in the art.

In alternative embodiment, the plate (33) of the invention may include a coupler positions (not shown) that is configured to be secured to one or more display supports (2,3). In this preferred embodiment, the internal surface of the plate (33) may include a coupler, or fitted extension that can be secured to a corresponding coupler position on the corresponding display supports (2,3). In one preferred embodiment, the plate (33) may be configured to be coupled with the support rail (29), for example through a fitted extension or hook that is secured in the notch (29) or other fastener or mechanical coupler position.

Referring now to FIGS. 16, and 20-21, in this preferred embodiment an exemplary display support (2,3) is positioned adjacent to the horizontal edge of a frame (5) such that its corresponding support rail (28) is also positioned approximately adjacent to the horizontal edge of a frame (5). The frame catch (31) of the magnetic coupler (27) is further positioned below the extended portion of the edge of the frame (5) such that the contact surface (32) is brought into contact with the underside of the extended portion of the frame (5). The plate (33), being secured to the rear surface of the frame catch (31) is positioned flush with the rear surface of the frame (5) and extends upward. Notably, the plate (33) of the invention is made of a magnetically responsive metal, or includes a magnetically responsive metal region. Notably, in alternative embodiments, the plate may include a magnetic portion, while a magnetically responsive metal components may be secured along a support rail forming an equivalent magnetic coupling.

As shown in FIG. 20, in a preferred embodiment, a magnet (30) secured within the notch (29) of the support rail (28) can be positioned to be adjacent to the plate (33) such that the plate is magnetically secured in place thereby holding the display support (2,3) adjacent to the edge of the frame (3). Notably, the number and position of magnetic couplers (27) can vary depending on the size and number of display supports (2,3) required or desired to secured to the frame (5). The magnetic couplers (27) of the invention being approximately flush with the rear surface of the frame (5) allows the corresponding exemplary canvas wrap (10) to be secured in a flush manner with a wall or other external surface.

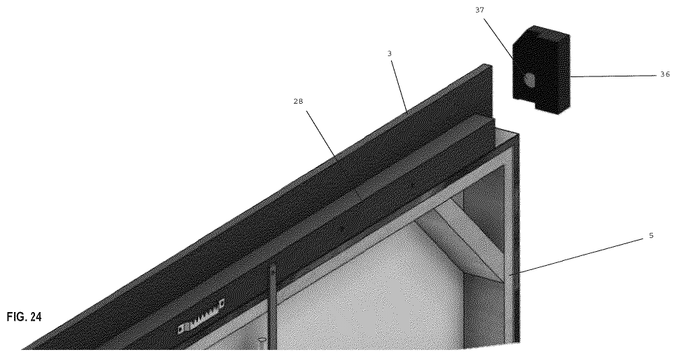

The invention may include one or more end-caps, and in a preferred embodiment a magnetic end-cap (36). Referring to FIGS. 22-24, in one preferred embodiment an end cap (36) may be configured to be secured to the terminal portion of a display support (2,3). The end cap (36) of the invention can be configured to have the same approximate shape as the display support (2,3) so as to provide a continuous and consistent pattern, in alternative embodiment, the end cap (36) of the invention may include a separate, non-continuous or decorative design that can accept the display support (2,3) and display surface (9) of an exemplary canvas warp (10).

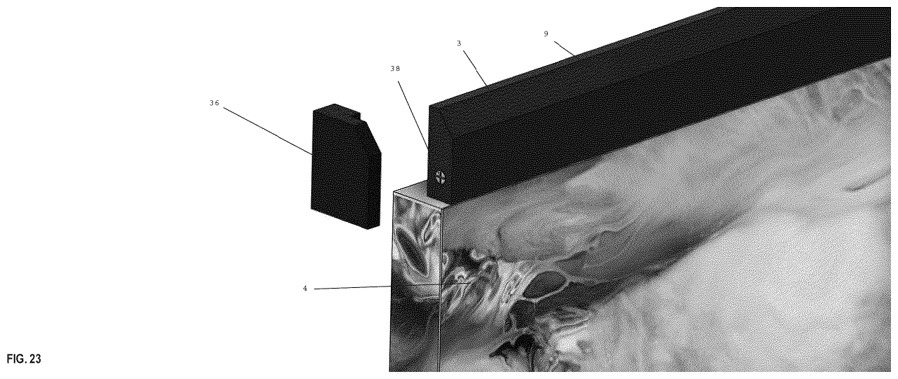

Referring again to FIGS. 22-24, the end cap (36) of the invention may include an end cap magnet (36) positioned on the surface of the end cap (36). The position of the end cap magnet (36) can correspond to magnetic coupler position (38) on the terminal portion of an exemplary display support (2,3). As shown in FIG. 23, in one embodiment, the magnetic coupler position (38) can include a magnetically responsive metal component. In this configuration, the end cap (36) can be positioned adjacent to the terminal edge of an exemplary support display support (2,3) such that the end cap magnet (36) is positioned adjacent to the magnetic coupler position (38) forming a magnetic coupling.

Notably, different embodiments include alternative methods of securing one or more end caps (36) to display support (2,3). For example, in certain embodiments, the end cap (36) of the invention may include one or more fasteners, as well as a coupler, such as snap, slide, spline, flange or quick release couplers. In other embodiments, the end caps (36) may include a fitted shape that forms a secure joint with the terminal edge of a support display support (2,3), such as a dovetail, tongue and groove, a mortis and tenon, and/or a dowel joint.

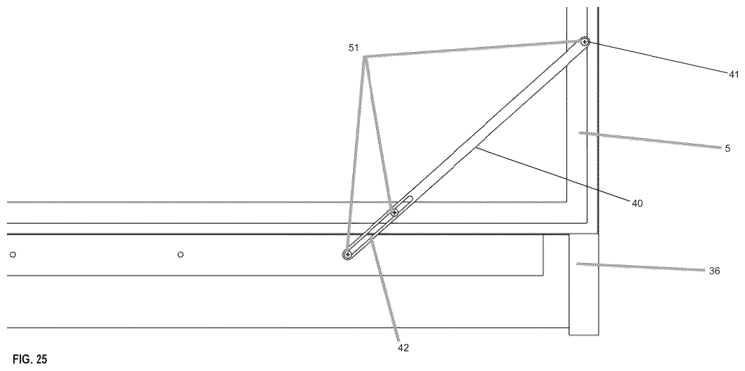

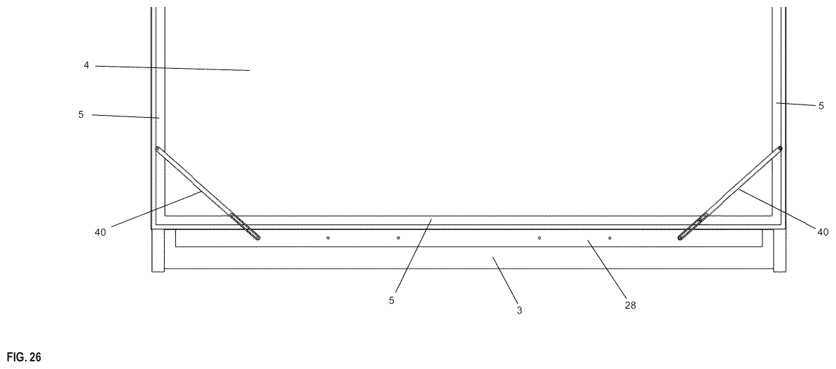

The invention may further include methods and apparatus to secure one or more display support (2,3) to a frame (5), and preferably the frame of a canvas wrap (10) display. As shown in FIG. 25-27, the invention can include one or more pivot fasteners (40). In the preferred embodiment shown in the figures, the pivot fastener (40) of the invention can slot (42) positioned at one end, along with a fastener position (41) positioned on the opposing end of the components. In this configuration, a fastener, such as a screw, nail or other fastener know to those of ordinary skill can be used to secure the fastener position to the vertical side of a frame (5). The opposing end of the pivot fastener (40) can be angled downward and toward the centerline of the horizontal edge of the frame (5). In this configuration, the angle of the pivot fastener (40) can be adjusted such that the terminal portion of the slot (42) is positioned over exemplary display support (2,3), and further secured with a fastener. At a proximal position of the slot (42) as fastener is positioned to be secured to the horizontal edge of the frame (5). Depending on the angle of the pivot fastener, and the dimension of the frame (5), the position of the fasteners in the slot (42) can be variable.

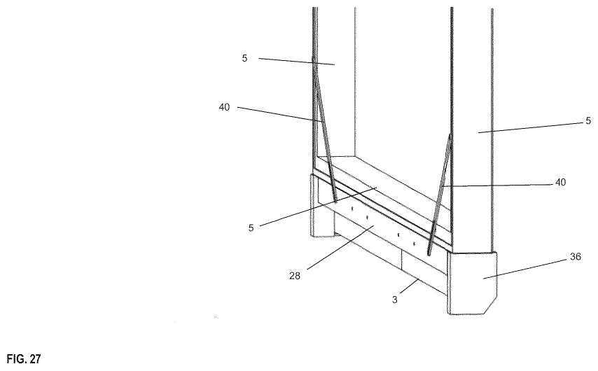

As shown in FIG. 26, the terminal fastener in the slot (42) may be secured to an extended portion of the display support (2,3) such as a support rail (28) or equivalent component. As further shown in FIG. 27, one or more pivot fasteners (40) can be used to secure a frame (5) to one or more display supports (2,3) and preferably the corner portions using one or more couplers (51). Finally, as also shown in FIG. 27, the pivot fastener(s) (40) of the invention can be made of a metal or composite material that is approximately planar so as to be flush with a wall or other external surface when the frame is mounted.

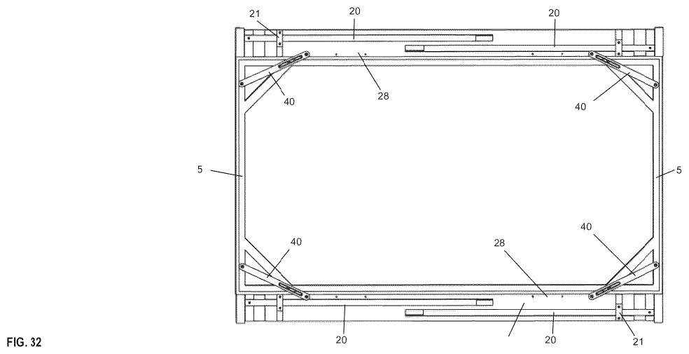

As further shown in FIGS. 31-32, one or more pivot fasteners (40) can be used to secure a frame (5) to an expandable canvas wrap frame mount (14) as described herein. In this embodiment, the terminal fastener in the slot (42) may be secured to an extended portion of the display support (2,3), such as a support rail (28) or equivalent component, which may be extendable as generally describe herein. The opposing end of the pivot fastener (40) can be angled downward and toward the centerline of the horizontal edge of the frame (5). In this configuration, the angle of the pivot fastener (40) can be adjusted such that the terminal portion of the slot (42) is positioned over exemplary display support (2,3), and further secured with a fastener. As shown in the figure, in certain embodiment, the angle and position of the pivot fastener (40) can be adjusted based on the position of the of the display support (2,3), such as a support rail (28), and may further lock the expandable canvas wrap frame mount (14) into a fixed position, that can be further adjusted and re-fastened to accommodate a different sized frame (5) as discussed above.

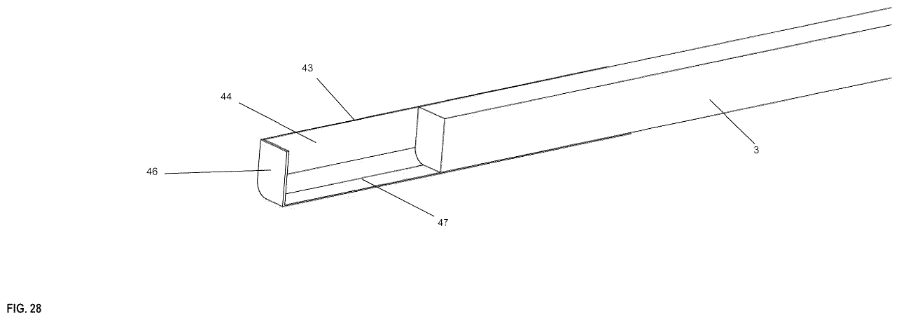

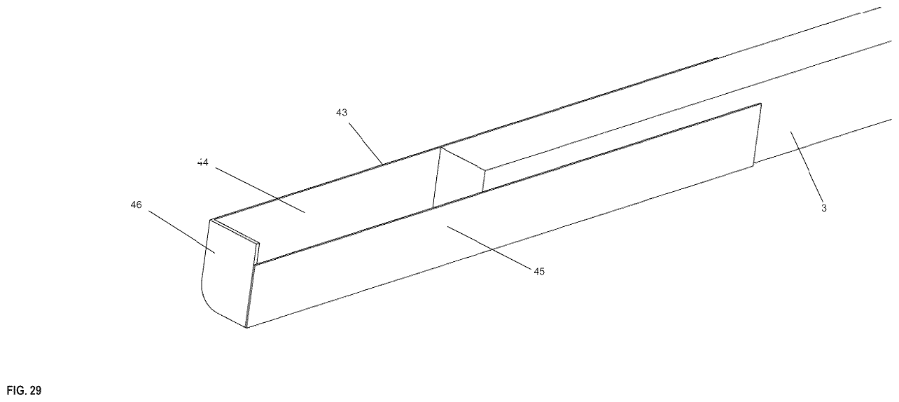

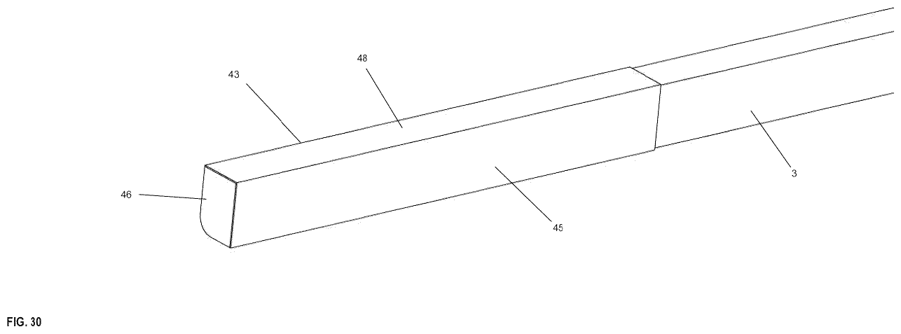

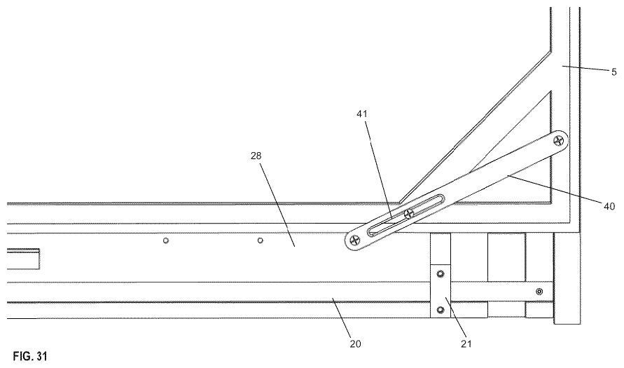

The invention may further include methods and apparatus for the horizontal extension of the surface of a display support (2,3). Referring to FIGS. 28-30, in one preferred embodiment the invention may include an extendable display surface (43) that can be formed of a shaped metal, molded or composite material to be slidably positioned over the ends of an exemplary display support (2,3). As shown in FIG. 28, in one embodiment the extendable display surface (43) of the invention may include at least a front and edge surfaces (44, 47) that form an extendable channel (48) that approximately matches the shape of and profile of the display support (2,3), and further include an end surface (46) that can further preferably match the profile of the terminal portion of the corresponding support. Alternative embodiments can include extendable display surface (43) having a front and edge surface (44, 47), as well as a back and/or top surfaces (47, 48). As noted above, extendable display surface (43) can be slidably engaged over the display support (2,3) and moved outward extending the visible length of the profile of the corresponding support. In certain embodiments the extendable display surface (43) can be adjustable coupled with a corresponding support by a fitted joint, a rail coupler, an adjustable fastener, or plurality of fixed fastener positions. Again, as shown in FIGS. 30-31, these alternative extendable display surfaces (43) can be slidably positioned over the terminal portions of a corresponding display support (2,3) and extended outward, for example to accommodate a frame (5) having a width that is larger than the length or height of the display support (2,3).

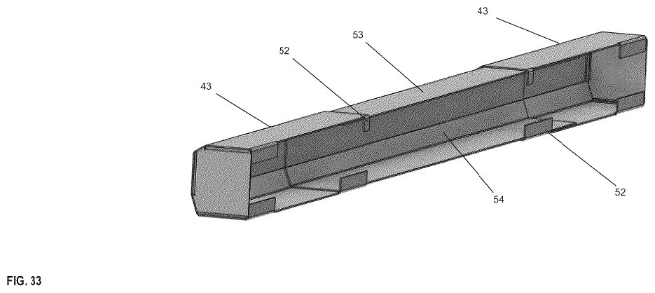

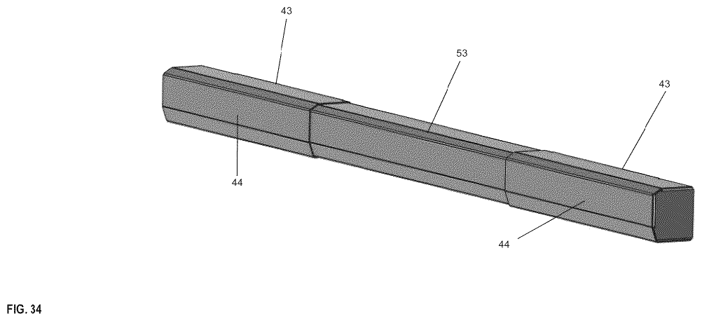

The invention may further include a display cover (53) configured to act as a display support (2,3) as generally described herein, or in a preferred embodiment, configured to be positioned over a display support (2,3). As shown in FIG. 33-34, the display cover (53) can be a shaped or decorative component that is configured to be secured to a display support (2,3). As shown in FIG. 33, in one embodiment, the display cover (53) of the invention can be formed of a shaped metal components, or other molded or similarly configured material. In this configuration, one or more tabs (52) can be positioned on the rear top and/or bottom surfaces display cover (53) can be positioned so as to secured a corresponding display support (2,3) internally within the cover. In this embodiment, the display cover (53) can slide over a display support, or be secured directly.

As further shown in FIGS. 33-34, one, or preferably a pair of extendable display surfaces (43) can be slidably positioned over the terminal portions of a corresponding display cover (53) as generally described herein. In a preferred embodiment, the extendable display surfaces (43) of the invention can also contain one or more table to provide a securement positions for a display support (2,3) positioned within the internal channel (54) formed by the cover (53) and the extendable display surfaces (43). In a preferred embodiment, a display support (2,3) can be positioned within the internal channel (54) of the cover and secured by the one or more tabs (52) of the invention. Next, one or both of the extendable display surfaces (43) of the invention are slidably engaged over the cover (35). The display support (2,3) can be secured to a frame (5) as described herein and the extendable display surfaces (43) can further positioned so as to be preferably flush with the horizontal edge of a corresponding frame (5). In this configuration, the invention can be adapted to accommodate frames (5) having differing lengths and widths. In alternative embodiments, a frame (5) may be secured to a cover (53) such that the cover comprises a display support, which may further be coupled with one or more extendable display surfaces (43) as described herein.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, and techniques as well as devices to accomplish a novel canvas wrap frame mount. In this application, the techniques, including novel and unique uses of manufacturing methods and materials, are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also methods or process claims may be included to address the functions the inventive technology and each element performs. Neither the description nor the terminology is intended to limit the scope of the claims that will be included in any subsequent patent application.

It should also be understood that a variety of changes can be made without departing from the essence of the inventive technology. Such changes are also implicitly included in the description. They still fall within the scope of this inventive technology. A broad disclosure encompassing both the explicit embodiment(s) shown, the great variety of implicit alternative embodiments, and the broad apparatus, methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of “coupler method and/or technique, and or device.” Such changes and alternative terms are to be understood to be explicitly included in the description.

Thus, the applicant(s) should be understood to have support to claim and make a statement of invention to at least: i) each of the methods, apparatus, improvements and/or devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-37. (canceled)

38. An extendable display surface device comprising:
a cover having front surface forming an internal channel securing a display support;
one or more extendable display surfaces slidably coupled to the terminal portion of the cover.

39. The device of claim 38, wherein the extendable display surface further comprises a back surface.

40. The device of claim 38, wherein the extendable display surface further comprises an end surface.

41. The device of claim 38, wherein the extendable display surface further comprises a top surface.

42. The device of claim 38, wherein the extendable display surface is flush with the display support positioned within the cover.

43. The device of claim 38, wherein the extendable display surface is a metal or a composite material.

44. The device of claim 38, wherein said display support is secured to a frame.

45. The device of claim 38, wherein said extendable display surface is secured to said cover by a coupler selected from: a fitted joint, a rail coupler, an adjustable fastener, or plurality of fixed fastener positions.

46. The device of claim 38, wherein said cover comprises one or more tabs securing the display support.

47. The device of claim 38, wherein said extendable display surface comprises one or more tabs configured to secure the display support

48. The device of claim 38, wherein said cover is secured to a frame.
